(19) United States
(12) Patent Application Publication
(10) Pub. No.: US 2003/0201353 A1
(43) Pub. Date: Oct. 30, 2003

(54) Dual-path office product disintegrator

(76) Inventors: David Lefrancois, Uxbridge, MA (US); Peter Dempsey, West Newton, MA (US); Leonard Rosen, Boston, MA (US)

Correspondence Address: BLODGETT BLODGETT, 43 HIGHLAND STREET, WORCESTER, MA, 016092797

(21) Appl. No.: 10/336,644

(22) Filed: Jan. 3, 2003

Related U.S. Application Data
(60) Provisional application No. 60/345,675, filed on Jan. 3, 2002.

(51) Int. Cl. B02C 18/22

(52) U.S. Cl. 241/236

(57) ABSTRACT

This invention is a dual-path disintegrator having a first path which carries bulk office products to a disintegrator, such as a rotary knife mill, for high security destruction, and a second path which carries sheets of paper through a shredder, either cross cut or strip cut, and then through a disintegrator, such as a rotary knife mill, for final high security destruction.

### CROSS REFERENCE TO RELATED APPLICATIONS

This application claims the benefit under 35 U.S.C. §119(e) of U.S. Provisional Application No. 60/345,675 filed Jan. 3, 2002, and all of which is hereby incorporated by reference

### STATEMENT REGARDING FEDERALLY SPONSORED RESEARCH OR DEVELOPMENT

This invention has been created without the sponsorship of a federally sponsored research or development program.

### BACKGROUND OF THE INVENTION

The need for personal and business security has become extremely urgent, especially because of events that have occurred during the recent past. Within this security concern is the need to provide a convenient and reliable way to render various office products such as letters, memoranda, books, videocassettes, identification badges, photographs, photographing slides, and computer disks unreadable and the information recorded in or on the products nonrecoverable.

Generally, the destruction of office products. Including their information content has employed two separate technologies. The destruction of bulk products, that is, office products that are not sheets of paper, typically required a disintegrator. A disintegrator is typically a rotary knife mill in which a series of industrial knives mounted on a rotating cylinder act against peripheral stationery blades to shear paper, plastic and light gauge metal. The disintegrator typically includes a sizing screen that keeps the material being destroyed in the mill until the particles reach a specified size. In a security application, a 3/32-inch or smaller particle is required/specified in order to make it essentially impossible to reconstruct the original office product/media. Thus, the rotary knife mill technology provides a very effective way to render office products unreadable. However the typical rotary knife mill is extremely expensive, large in size, and power restrictive, they can the inefficient in handling some kinds of office products such as sheets of paper, and, because they are noisy and somewhat intimidating, they generally must be enclosed deeply within a surrounding sound-quieting cabinet.

Sheets of paper have been destroyed by a much less expensive and less complicated technology generally referred to as shredders. Shredders typically come in two forms; strip cutters, which cut the sheets of paper into strips ranging from 5/32 to one inch wide, and cross cut shredders which cut the sheets into small pieces of approximately 5/64 by 9/16 inches to as small as 1/32 by 1/2 inch.

Where high security was needed, it was found that the product of strip cutters could be too easily reconstructed. Therefore, crosscut shredders were generally required for high security documents. However, recent developments have made it practical to reconstruct even the products of cross cut shredders. Therefore, the use of disintegration or highly modified cross cut shredders will be required for high security situations.

Although the effectiveness of disintegrator for rendering both bulk materials and paper unreadable suggests that disintegrator technology is essential, the inefficiency of a disintegrator for processing paper raises problems. For a given throughput of office products to be destroyed, it is not always practical to simply provide bigger, higher-throughput rotary knife mills. Even in industrial situations, the increased cost, size, and power requirements, especially specialized power requirements such as three-phase electricity, create problems for practical use of rotary knife mills. Attempts at designing dual-stage shredder/disintegrators in which all of the office products, both bulk and paper are first passed through a shredder and then passed through a disintegrator have increased the efficiency of the disintegrator to handle paper. However, designing a shredder that can handle bulk material creates numerous practical and cost problems that limit this approach to the large-scale industrial context and creates severe cost difficulties.

These difficulties with rotary knife mills become even more difficult in office or home office environments. It is costly, inconvenient, and otherwise impractical to have to separate machines for bulk and for paper destruction, even if shredders could provide sufficient destruction. On the other hand, the cost, noise, and power requirements of a rotary knife mill of sufficiently large capacity to handle large paper loads is impractical in the office environment.

These and other difficulties experienced with the prior art devices have been obviated in a novel manner by the present invention.

It is, therefore, an outstanding object of the present invention to provide a disintegrator that is capable of efficiently rendering both bulk and paper office products unreadable.

Another object of this invention is to provide a disintegrator that overcomes the efficiency problems of destroying paper using a rotary knife mill.

A further object of the present invention is to provide a disintegrator that can be designed to be appropriate for use in an office or home office environment, in terms of noise, size, cost, and power requirements.

It is a further object of the invention to provide a disintegrator that is capable of being manufactured of high quality and at a low cost, and which is capable of providing a long and useful life with a minimum of maintenance.

With the foregoing and other objects in view, which will appear as the description proceeds, the invention resides in the combination and arrangement of parts and steps hereinafter described and claimed, it being understood that changes in the precise embodiment of the invention herein disclosed may be made within the scope of what is claimed without departing from the spirit of the invention.

### BRIEF SUMMARY OF THE INVENTION

This invention is a dual-path disintegrator having a first path which carries bulk office products to a disintegrator, such as a rotary knife mill, for high security destruction, and a second path which carries sheets of paper through a shredder, either cross cut or strip cut, and then through a disintegrator, such as a rotary knife mill, for final high security destruction.

### BRIEF DESCRIPTION OF THE DRAWINGS

The character of the invention, however, may best be understood by reference to one of its structural forms, as illustrated by the accompanying drawings, in which:

FIG. 1 is a schematic view of a dual-path disintegrator embodying the principals of the present invention.

### DETAILED DESCRIPTION OF THE INVENTION

This invention is a dual-path disintegrator having a first path which carries bulk office products to a disintegrator, such as a rotary knife mill, for high security destruction, and a second path which carries sheets of paper through a shredder, either cross cut or strip cut, and then through a disintegrator, such as a rotary knife mill, for final high security destruction.

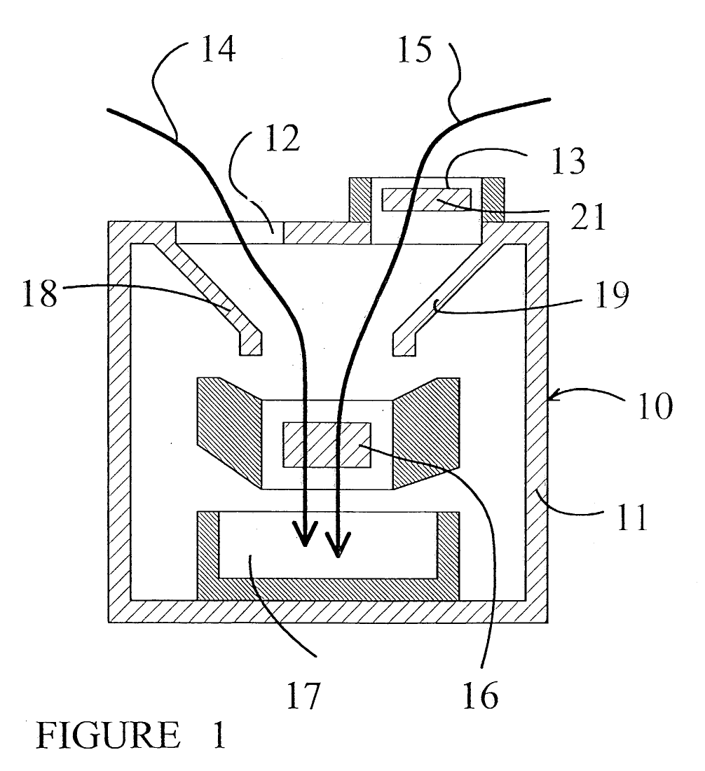

Referring to FIG. 1 in which are shown the general features of the present invention, the dual-path disintegrator of the present invention, generally referred to by numeral 10, is shown to include an enclosure 11, suitable for its intended environment such as an office, and, in the enclosure 11, a first input port 12 and second input port 13. The input port 12 is suitable for feeding bulk office products into the enclosure 11 for destruction. The input port 13 is suitable for feeding sheets of paper into the enclosure 11 for destruction. First path 14 passes through input port 12. Second path 15 passes through input port 13. Within the enclosure 11 is a disintegrator, such as a rotary knife mill 16. Also within the enclosure 11 is a product-receiving bin 17, suitable for receiving the output of the disintegrator 16. A vacuum system, not shown, may be provided to empty out the bin 17. Also present in the enclosure 11 are channeling structures 18 and 19, which defined the paths 14 and 15. Associated with input port 13 is a shredder 21, within path 15.

The manner in which the dual-path disintegrator of the present invention operates will be described.

Bulk office products are fed along path 14 through the input port 12. The bulk material is guided by channeling structure 18 into the disintegrator 16 for total destruction. The resulting particles are collected in bin 17.

Sheet paper is fed along path 15 into input port 13. The sheet paper then is fed through the shredder 21. The shredded product is then guided by channeling structure 19, into the disintegrator 16. The disintegrator 16 totally destroys the shredded paper into unreadable and unreconstructable particles and the particles are collected in bin 17.

In a prototype system, a separate rotary knife mill was found to have a sheet paper destruction rate of 25 pounds/hour. When the sheet paper was shredded, first, the sheet paper destruction rate of the rotary knife mill rose to 50 pounds/hour.

It is important to distinguish between the shredder element of this invention and the disintegrator element. The shredder element is designed to use the relative motion of two or more blades to reduce the size of sheet material using a scissors-type action. The action is of a laminar shear nature so the sheets are cut with relatively low power demand. The shredder is not designed or suitable for shredding bulk or tough material. The thickness and sheet nature of the material is not generally altered so material printed on the resulting pieces is still intact. As an alternative to the preferred embodiment, the shredder could include other devices that are operated to cause substantially the same result.

The disintegrator element is a difference type of device which is designed to destroy bulk and/or tough materials using relatively large force and bulk shear. The preferred embodiment, called a rotary knife mill, is designed to use the relative motion of one or more rotating rotor or fly blades (preferable three), mounted on a rotating rotor, the rotor blades acting against one or more (preferably two) stationary or bed knives, to reduce the size of material using a cutting and bulk shearing action. A control screen only releases the material from the knife zone after the material is reduced to the desired small size. The action can be of a bulk shear (kneading) nature so the material is transformed with relatively high power demand. The disintegrator is designed and suitable for destroying, that is, comminuting, bulk or tough material. The thickness and any sheet nature of the material is generally altered, so material printed on the resulting pieces is rendered unreadable. Likewise, information which is present in the bulk material, by magnetic, optical, or textural recording will be render unreadable and nonrecoverable. As an alternative to the preferred embodiment, the disintegrator could include other devices that are operated to cause substantially the same result, such as grinders, granulators, chippers, and comminutors.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. A device for high security destruction of sheets of paper and bulk office products containing information, comprising
a.) a first path that carries bulk office products to a disintegrator which is adapted for final high security destruction of the information in the bulk office products,
b.) a second path that carries sheets of paper through a shredder, to pre-shred the paper, and then through the disintegrator, for final high security destruction of the information on paper, and
c.) wherein the first path does not carry the bulk office products through the shredder.

2. A device as recited in claim 1, wherein the disintegrator is a rotary knife mill.

3. A device as recited in claim 1, wherein the shredder is a cross cut shredder.

4. A device as recited in claim 1, wherein the shredder is a strip cut shredder.

5. A device as recited in claim 1, wherein the device comprises a first input port for feeding the bulk office products to the first path and a second input port, separate from the first input port, for feeding sheets of paper to the second path.

6. A device as recited in claim 1, wherein the bulk office products are selected from the group consisting of letters, memoranda, books, videocassettes, identification badges, photographs, photographic slides, and computer disks.

7. A device as recited in claim 1, wherein the bulk office products are selected from the group consisting of books, videocassettes, identification badges, photographic slides, and computer disks.

8. A device as recited in claim 1, wherein the device is designed to be suitable for use in an office, home, or medical clinical environment.

9. A device for high security destruction of information on sheets of paper and in bulk office products, comprising
a.) a first path that carries bulk office products to a disintegrator, which is a rotary knife mill, which is adapted for final high security destruction of the information in bulk office products,
b.) a second path that carries sheets of paper through a shredder, wherein the shredder is a cross cut or strip cut shredder, to shred the paper, and then through the disintegrator, for final high security destruction of the information on the paper,
c.) wherein the first path does not carry the bulk office products through the shredder,
d.) wherein the device comprises a first input port for feeding the bulk office products to the first path and a second input port, separate from the first input port, for feeding sheets of paper to the second path,
e.) wherein the bulk office products are selected from the group consisting of books, videocassettes, identification badges, photographic slides, and computer disks, and
f.) wherein the device is designed to be suitable for use in an office, home, or medical clinical environment.

10. A device for high security destruction of print on sheets of paper, comprising a path that carries sheets of paper through a shredder, to shred the sheets of paper, and then through a disintegrator, for final high security destruction of the print on the paper.

11. A device as recited in claim 10, wherein the disintegrator is a rotary knife mill.

12. A device as recited in claim 10, wherein the shredder is a cross cut shredder.

13. A device as recited in claim 10, wherein the shredder is a strip cut shredder.

14. A device as recited in claim 10, wherein the device comprises an input port for feeding the sheets of paper to the path.

15. A device as recited in claim 10, wherein the device is designed to be suitable for use in an office, home, or medical clinical environment.
